(19) United States
(12) Patent Application Publication
(10) Pub. No.: US 2018/0246071 A1
(43) Pub. Date: Aug. 30, 2018

(54) Increasing the Sensitivity of Gas Chromatography and Gas Chromatography-Mass Spectrometry Analysis By Allowing Relatively Large Solvent Volume Injections While Reducing Sample Loss And System Contamination

(71) Applicant: Entech Instruments Inc., Simi Valley, CA (US)

(72) Inventor: Daniel B. CARDIN, Simi Valley, CA (US)

(21) Appl. No.: 15/908,491

(22) Filed: Feb. 28, 2018

Related U.S. Application Data
(60) Provisional application No. 62/465,143, filed on Feb. 28, 2017.

(51) Int. Cl. G01N 30/12

(52) U.S. Cl. CPC G01N 30/12; G01N 2001/4027

(57) ABSTRACT

The disclosure is related to preparing a sample for chemical analysis by evaporating at least a portion of solvent included in the sample. After depositing the sample into a sample container, in some examples, at least a portion of the solvent can be evaporated. Solvent evaporation can be achieved at room temperature, at an elevated temperature, at atmospheric pressure, or by drawing a vacuum in the sample container, for example. The one or more compounds of interest can pass through a sample delivery port on the sample container into the chemical analysis device for analysis, for example. Preliminary reduction or elimination of the solvent can increase the overall amount of compounds of interest delivered into the chemical analysis device, for example. In some examples, when extra sensitivity may not be needed, less solvent can be used, which can result in a greener analytical technique that is better for the environment.

### CROSS-REFERENCE TO RELATED APPLICATIONS

This application claims the benefit of U.S. Provisional Application No. 62/465,143, filed on Feb. 28, 2017, the entire disclosure of which is incorporated herein by reference in its entirety for all intended purposes.

### FIELD OF THE DISCLOSURE

This relates to a method for performing a chemical analysis of a sample and, more particularly, to chemical analysis using various chromatography techniques such as gas chromatography (GC), gas chromatography-mass spectrometry (GCMS), liquid chromatography (LC) and/or liquid chromatography-mass spectrometry (LCMS).

### BACKGROUND OF THE DISCLOSURE

GC, GCMS, LC and LCMS are techniques of performing analysis of trace chemicals in a wide range of sample matrices. In some examples, these techniques can be used to study biological matrices such as breath, blood, and urine; to study trace chemicals in food, water, and air; to detect odors in foods, beverages, products, and water supplies; and/or to analyze pharmaceuticals dissolved in water.

In some examples, samples for GC, GCMS, LC, and LCMS can be prepared using solvent extraction, of which some examples include liquid-liquid extraction, liquid-solid extraction, Soxhlet extraction, Solid Phase Extraction, or QuEChERS extraction, to name a few. Solvent extraction can include transferring one or more solutes from a feed solution to a solvent to form an extract, which can then be analyzed by GC, GCMS, LC, LCMS, or other analytical techniques, for example. Solvent extraction generally requires large amounts of solvent and sample. In some examples, the solvent-extracted sample is injected into a chemical analysis device using a hot injector. This technique can result in the rapid expansion of the sample, which, in some examples, may limit the amount of sample injected (e.g., to 1 to 2 microliters) to reduce or prevent backward expansion into cold carrier gas delivery lines. Since typical solvent extractions can result in 1000-2000 microliters of extract, the limited ability in the amount of sample that can be injected can, in some examples, severely limit the amount of the sample that can be delivered to the analyzer. In some examples, only a small fraction of the total extract may be delivered to the analyzer. Thus, traditional techniques of extract delivery can suffer from poor sensitivity due to the large dilution factor that can be inherent with current sample delivery techniques, for example. In some examples, these techniques can result in large amounts of wasted sample. Thus, there exists a need for a large injection method which reduces the dilution factor and increases the total percentage of extract delivered to the chemical analysis device, thereby improving the sensitivity of the chemical analysis and avoiding waste of the sample.

### SUMMARY OF THE DISCLOSURE

This disclosure relates to a method for performing chemical analysis on a sample and, more particularly, to a method for performing analysis techniques such as gas chromatography (GC), and/or gas chromatography-mass spectrometry (GCMS). As used herein, an extract can include a number of compounds of interest and a solvent, though in some examples, the solvent can be eliminated completely during a sample concentration process. In some examples, a sample may first be prepared. Preparing the sample may include extracting one or more compounds of interest from an environment using a solvent and a sample extraction device, for example. In some examples, a sample container tray may accommodate a plurality of sample containers or cups. The extract containing the compounds of interest to be analyzed and the solvent used in the sample preparation process can be deposited in a sample container or cup, for example. In some examples, the extract contains one or more compounds of interest and a solvent. After the extract is placed in the one or more sample cups, at least a portion of the solvent (e.g., a portion of the solvent, all of the solvent, substantially all of the solvent, etc.) can be evaporated from the sample container or cup, for example. As an example, the solvent can be evaporated at atmospheric pressure at room temperature, or the sample container or cup may be heated or warmed (e.g., placed on a warm surface). In some examples, the sample container or cup can be placed under a vacuum at room temperature or an elevated temperature to evaporate the solvent. In some examples, solvent evaporation is achieved by using a sample container delivery device similar to a Sorbent Pen™, disclosure of which can be found in U.S. patent application Ser. No. 15/450,236, which is incorporated by reference herein in its entirety for all purposes. The sample container delivery device can contain a sorbent configured to absorb or adsorb one or more compounds of interest to reduce or prevent loss of lighter compounds within the extract during solvent evaporation, for example. In some examples, the sample container delivery device does not include a sorbent. In some examples, the sample container delivery device is removably coupled to the sample container or cup. Solvent evaporation is achieved by, for example, drawing a vacuum through an internal seal of the sample container delivery device while the sample container or cup is attached to the sample container delivery device. In some examples, the solvent can evaporate through a solvent evacuation port in the sample container delivery device. In some examples, the solvent evacuation port in the sample container delivery device can be disposed between external seals of the sample container delivery device.

In some examples, after evaporation of all, substantially all, or a portion of the solvent, a concentrated sample including all or substantially all of the compounds of interest remains in the sample container or cup. In some examples, some evaporated compounds of interest may be adsorbed or absorbed by the sorbent in the sample container delivery device. In some examples, the adsorbed or absorbed compounds of interest may be desorbed from the sorbent during the delivery of the concentrated sample (i.e., the compounds remaining in the sample container along with those collected in the sorbent). The concentrated sample (e.g., one or more compounds of interest and any remaining solvent) can then be delivered into the chemical analysis device for chemical analysis (e.g., GC, GCMS, LC, or LCMS). In some examples, the concentrated sample passes through a sample delivery port on the sample container. The concentrated sample can flow into a pre-column and/or a primary column of a chemical analysis device configured to perform GC, GCMS, LC, LCMS, and/or some other sample analysis procedure. Preliminary reduction or elimination of the solvent can improve the injection rate, reduce or eliminate analyzer contamination risk caused by back expansion of the solvent and sample into carrier gas delivery lines, and can increase the overall amount of compounds of interest delivered into the chemical analysis device, for example. In some examples, increasing the concentration of one or more compounds of interest delivered into the chemical analysis device and used during each analysis can increase the detection sensitivity during chemical analysis. In some examples, when extra sensitivity may not be needed, analyzing a larger fraction of the extract decreases the amount of sample needing to be extracted in the first place, thereby allowing less solvent to be used, which can result in a greener analytical technique that is better for the environment.

### BRIEF DESCRIPTION OF THE DRAWINGS

FIG. 1A illustrates an exemplary chemical analysis device, an exemplary sample container delivery device, and an exemplary sample container according to examples of the disclosure.

FIG. 1B illustrates an exemplary process for performing a chemical analysis procedure using a sample delivery device, desorption device, chemical analysis device, and detector according to examples of the disclosure.

FIGS. 2A-2C illustrate exemplary sample container delivery devices according to examples of the disclosure.

FIGS. 3A-3B illustrate exemplary sample cups according to examples of the disclosure.

FIGS. 4A-4B illustrate exemplary sample container delivery devices coupled to exemplary sample cups according to examples of the disclosure.

FIGS. 5A-5B illustrate an exemplary sample container tray according to examples of the disclosure.

FIGS. 6A-6B illustrate exemplary sample cups according to examples of the disclosure.

FIG. 7 illustrates an exemplary process for performing chemical analysis of a sample according to examples of the disclosure.

FIGS. 8A-8B illustrate exemplary sample container delivery devices coupled to exemplary sample cups according to examples of the disclosure.

FIG. 9 illustrates an exemplary process for using a sample container delivery device according to examples of the disclosure.

### DETAILED DESCRIPTION

In the following description, reference is made to the accompanying drawings which form a part hereof, and in which it is shown by way of illustration specific examples that can be practiced. It is to be understood that other examples can be used and structural changes can be made without departing from the scope of the examples of the disclosure.

This disclosure relates to a method for performing chemical analysis on a sample and, more particularly, to a method for performing analysis techniques such as gas chromatography (GC), and/or gas chromatography-mass spectrometry (GCMS). As used herein, an extract can include a number of compounds of interest and a solvent, though in some examples, the solvent can be eliminated completely during a sample concentration process. In some examples, a sample may first be prepared. Preparing the sample may include extracting one or more compounds of interest from an environment using a solvent and a sample extraction device, for example. In some examples, a sample container tray may accommodate a plurality of sample containers or cups. The extract containing the compounds of interest to be analyzed and the solvent used in the sample preparation process can be deposited in a sample container or cup, for example. In some examples, the extract contains one or more compounds of interest and a solvent. After the extract is placed in the one or more sample cups, at least a portion of the solvent (e.g., a portion of the solvent, all of the solvent, substantially all of the solvent, etc.) can be evaporated from the sample container or cup, for example. As an example, the solvent can be evaporated at atmospheric pressure at room temperature, or the sample container or cup may be heated or warmed (e.g., placed on a warm surface). In some examples, the sample container or cup can be placed under a vacuum at room temperature or an elevated temperature to evaporate the solvent. In some examples, solvent evaporation is achieved by using a sample container delivery device similar to a Sorbent Pen™, disclosure of which can be found in U.S. patent application Ser. No. 15/450,236, which is incorporated by reference herein in its entirety for all purposes. The sample container delivery device can contain a sorbent configured to absorb or adsorb one or more compounds of interest to reduce or prevent loss of lighter compounds within the extract during solvent evaporation, for example. In some examples, the sample container delivery device does not include a sorbent. In some examples, the sample container delivery device is removably coupled to the sample container or cup. Solvent evaporation is achieved by, for example, drawing a vacuum through an internal seal of the sample container delivery device while the sample container or cup is attached to the sample container delivery device. In some examples, the solvent can evaporate through a solvent evacuation port in the sample container delivery device. In some examples, the solvent evacuation port in the sample container delivery device can be disposed between external seals of the sample container delivery device.

In some examples, after evaporation of all, substantially all, or a portion of the solvent, a concentrated sample including all or substantially all of the compounds of interest remains in the sample container or cup. In some examples, some evaporated compounds of interest may be adsorbed or absorbed by the sorbent in the sample container delivery device. In some examples, the adsorbed or absorbed compounds of interest may be desorbed from the sorbent during the delivery of the concentrated sample (i.e., the compounds remaining in the sample container along with those collected in the sorbent). The concentrated sample (e.g., one or more compounds of interest and any remaining solvent) can then be delivered into the chemical analysis device for chemical analysis (e.g., GC, GCMS, LC, or LCMS). In some examples, the concentrated sample passes through a sample delivery port on the sample container. The concentrated sample can flow into a pre-column and/or a primary column of a chemical analysis device configured to perform GC, GCMS, LC, LCMS, and/or some other sample analysis procedure. Preliminary reduction or elimination of the solvent can improve the injection rate, reduce or eliminate analyzer contamination risk caused by back expansion of the solvent and sample into carrier gas delivery lines, and can increase the overall amount of compounds of interest delivered into the chemical analysis device, for example. In some examples, increasing the concentration of one or more compounds of interest delivered into the chemical analysis device and used during each analysis can increase the detection sensitivity during chemical analysis. In some examples, when extra sensitivity may not be needed, analyzing a larger fraction of the extract decreases the amount of sample needing to be extracted in the first place, thereby allowing less solvent to be used, which can result in a greener analytical technique that is better for the environment.

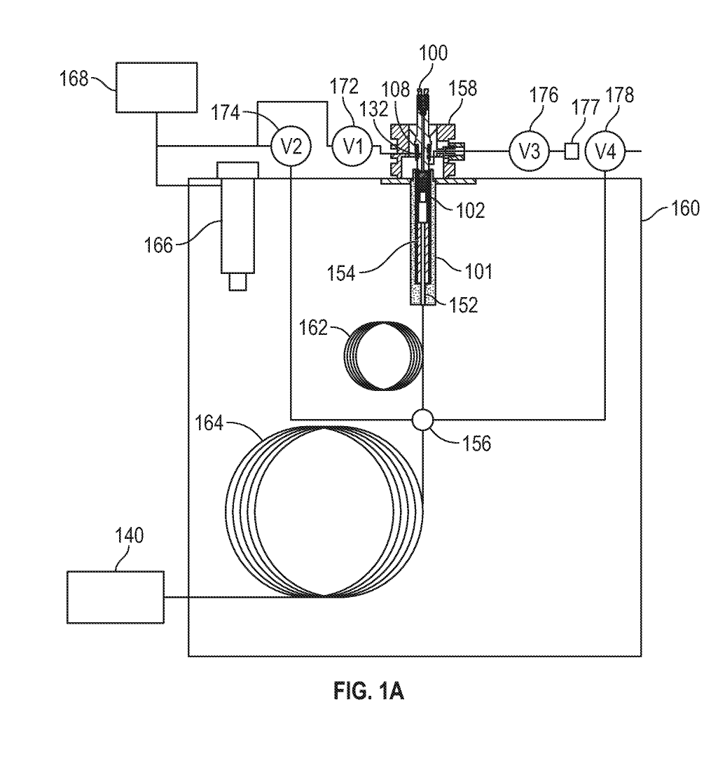

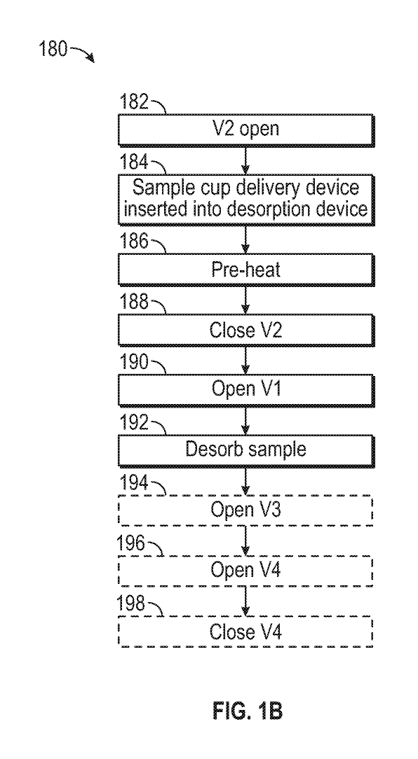

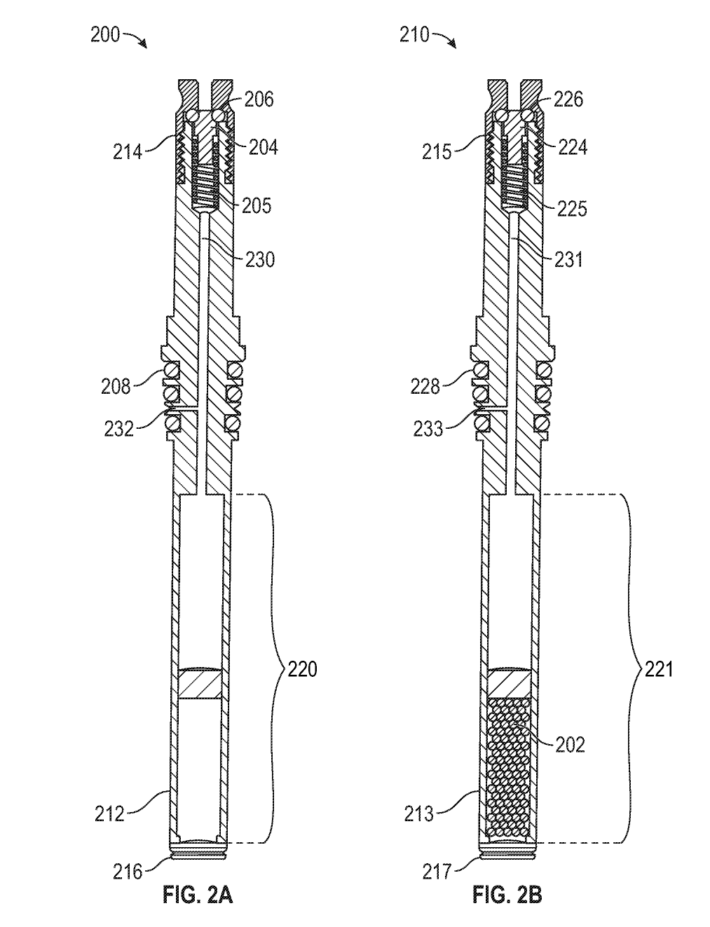

FIG. 1A illustrates an exemplary chemical analysis device 160, an exemplary sample container delivery device 100, an exemplary sample container 102, and detector 140 for conducting chemical analysis according to examples of the disclosure. In some examples, chemical analysis device 160 and detector 140 can correspond to a chromatograph configured to perform gas chromatography (GC), gas chromatography-mass spectrometry (GCMS), liquid chromatography (LC), liquid chromatography-mass spectrometry (LCMS) or some other form of chemical analysis, including other forms of chromatography (e.g., detector 140 can be a mass spectrometer for detecting samples passing through the chemical analysis device 160, such as a quadrupole mass spectrometer). The sample container 102 can house a sample that was previously evaporated in a solvent evaporation process, as will be described below with reference to FIGS. 2-8, for example. In some examples, the sample container 102 can be coupled to a sample container delivery device 100 or another suitable delivery device during sample delivery. Further disclosure may assume that sample container delivery device 100 is coupled to the sample container 102 during sample delivery and analysis of the sample. However, this is not meant to be limiting and is only for ease of description. In some examples, the sample container 102 can be coupled directly to the thermal desorption device 101 without the use of sample container delivery device 100. In some examples, before coupling the sample container 102 to the thermal desorption device 101, the temperature of the chemical analysis device 160 can be below the boiling point of the solvent in sample container 102. For example, this can reduce or prevent rapid expansion of any solvent in sample container 102 upon coupling the sample container 102 to the thermal desorption device 101.

In some examples, the chemical analysis device 160 can desorb sample from the sample container 102 using a thermal desorber configuration that will now be described. Specifically, in some examples, the chemical analysis device 160 can include divert vent 156, pre-column 162, primary column 164, injector 166, pressure controller 168, thermal desorption device 101 into which sample container 102 can be inserted for desorbing sample into chemical analysis device 160, and a plurality of valves 172-176, 178. In some examples, injector 166 can be a capped-off GC injector.

The desorption device 101 can be made of stainless steel and can optionally be lined with ceramic, and can include a replaceable liner 154 and heat sink 158. The replaceable liner 154 can improve transfer of the sample from the sample container 102 to the pre-column 162 and primary column 164 of chemical analysis device 160 without (or with minimal) chemical reactions, for example. Further, liner 154 can include channel 152 to fluidly couple the sample container 102 to the chemical analysis device 160. In some examples, heat sink 158 can protect rubber seals 108 between the sample container delivery device 100 and the desorption device 101 from excessive heat exposure and/or chemical outgassing. As an example, the rubber seals 108 can be included in the sample container delivery device 100 (as will be described below, e.g. with reference to FIGS. 2A-2B).

In some examples, during the chemical analysis process (e.g., GC or GCMS), the first valve 172 can control flow of a carrier fluid from pressure controller 168 through sample container delivery device 100 and sample container 102 for transfer of sample from the sample container 102 to the pre-column 162 and primary column 164. In some examples, the sample container delivery device 100 contains sorbent and carrier fluid can flow through the sorbent in the sample container delivery device 100, through sample container 102 and into pre-column 162. In some examples, the sample container delivery device 100 does not contain sorbent. The first valve 172 can be fluidly coupled to the sample container delivery device 100 by way of solvent evacuation port 132 of the sample container delivery device 100, for example. Depending on the chemical analysis procedure and in the disclosed configuration, the carrier fluid can be a gas (e.g., for GC or GCMS), though it is understood that in some configurations, the carrier fluid can be a liquid (e.g., for LC or LCMS). The second valve 174 can control the flow of fluid around (e.g., bypassing) the sample container delivery device 100 and pre-column 162 into divert vent 156 during preheating, for example. In some examples, the third valve 176 can control flow of fluid (flowing into sample container delivery device 100 via the first valve 172) directly out a split vent 177 to precisely and reproducibly reduce the amount of sample transferred to the pre-column 162 and primary column 164 and/or to increase sample injection rates into the chemical analysis device 160. In some examples, the combination of the second valve 174 and the third valve 176 can backflush the pre-column 162 to prevent contamination of the primary column 164 with heavier contaminants, for example. The fourth valve 178 can control flow of fluid out from a divert vent 156 downstream of the pre-column 162 for either high flow pre-column enrichment without splitting

Upon desorption of the sample, the sample can pass from the sample container 102 through the pre-column 162 and the primary column 164 at a rate controlled by controller 168 by way of controlling the pressure of the carrier gas and by controlling the temperatures and temperature ramp rates of the analyzer 160. For example, the temperature of chemical analysis device 164 can be increased at a rate to reduce or prevent rapid expansion of any remaining solvent during sample delivery. As the sample flows through the pre-column 162 and primary column 164, various compounds of the sample can move at different rates depending on compound mass, for example. In some examples, the sample can exit primary column 164 to enter the detector device 140, which can be used to identify the relative concentrations of compounds present in the sample based on time of arrival at the detector device 140 and by the mass fragmentation pattern of the compounds when using a mass spectrometer. In this way, the composition of the sample can be determined. Additionally or alternatively in some examples, the speed at which each compound travels through the pre-column 162 and the primary column 164 can be affected by one or more characteristics other than mass that determine the affinity of the compound to the columns 162 and 164.

FIG. 1B illustrates an exemplary process 180 for performing a chemical analysis procedure using sample container delivery device 100, sample container 102, desorption device 101, chemical analysis device 160, and detector device 140 according to examples of the disclosure. As an example, the chemical analysis process can be GCMS. To perform GCMS, the pressure controller 168 can supply a carrier gas, such as helium, nitrogen, or some other inert or non-reactive gas, which can flow through the sorbent inside sample container delivery device 100 (if any) and into pre-column 162 to facilitate sample desorption from the sorbent.

Initially, in step 182, the second valve 174 can be open, for example. In some examples, the sample container delivery device 100 can be inserted into the desorption device 101 in step 184 while second valve 174 is open. Next, in step 186, a pre-heat can occur while second valve 174 is open. In some examples, the pre-heat can take zero to three minutes, though other lengths of time are possible. After the pre-heat, the second valve 174 can be closed in step 188 and the first valve 172, which can be fluidly coupled to the sample container delivery device 100 by way of port 132 of the sample container delivery device 100, can be opened in step 190. The closing of second valve 174 and the opening of first valve 172 can cause the desorption of the sample in step 192, for example. For example, desorption of the sample may include desorbing the extract from the sorbent in sample container delivery device 100 (if any) and delivering the sample from the sample container 102 through the sample delivery port on the sample container 102 into a column of the chemical analysis device 160. In some examples, at step 194, the third valve 176 can be opened to optionally perform a split injection. Performing a split injection can precisely and reproducibly reduce the amount of sample transferred to the column and increase injection rates, for example. In some examples, the third valve 176 can be closed and the fourth valve 178 can be opened in step 196 to improve transfer of heavy sample chemicals to the pre-column 162 while excess gas flows out from the fourth valve 178. Alternatively, in some examples, the third valve 176 can be left closed during sample desorption steps 192-196 to achieve complete transfer of heavy compounds into the pre-column 162. After desorption, if the fourth valve 178 had been opened in step 196, it can be closed in step 198, for example. The third valve 176 can open or remain open to remove any residual sample left in the sample container delivery device 100 during a bake out process to clean the sample container delivery device 100 for reuse in another sample analysis. In some examples, sample container delivery device 100 can be reused hundreds of times in this way.

FIG. 2A illustrates an exemplary sample container delivery device 200 according to examples of the disclosure. In some examples, sample container delivery device 200 can correspond to sample container delivery device 100 in FIG. 1, and can be used for chemical analysis in a manner similar to that described with respect to FIG. 1. As an example, sample container delivery device 200 can have a diameter between 1/32 in. and ⅜ in. (e.g., the external or internal diameter of the sample container delivery device); in some examples, the diameter of sample container delivery device 200 can be as small as the diameters of the capillary columns (e.g., pre-column 162 and/or primary column 164) in a chemical analysis device. In some examples, other dimensions are possible. Sample container delivery device 200 can comprise a tube-like structure, for example, that includes various channels and/or cavities as will be described below. In some examples, sample container delivery device 200 can be fabricated from stainless steel, glass, or another suitable material (e.g., a material that is substantially inert). All or part of the surface of sample container delivery device 200 can be coated with a chemical vapor deposition (CVD)-deposited ceramic to increase the inertness of the sample container delivery device 200, for example. Other coatings that similarly increase the inertness of the sample container delivery device 200 can similarly be used.

Sample container delivery device 200 can include lower cavity 220. For example, lower cavity 220 can remain empty or can contain sorbent (as will be described in more detail below with respect to FIG. 2B). At the valve end 214 of the sample container delivery device 200 (e.g., opposite fastener end 212 of the sample container delivery device 200), the sample container delivery device 200 can include a sealing plunger 204, a spring 205, and an internal seal 206, for example. The internal seal 206 can be a fluoroelastomer seal, a perfluoroelastomer seal, or any other suitable seal, for example. In some examples, sealing plunger 204 and internal seal 206 can selectively restrict fluid (e.g., gas, liquid, etc.) flow through internal channel 230 between sealing plunger 204/internal seal 206 and lower cavity 220. For example, when sealing plunger 204 is pressed up against seal 206, fluid flow through sample container delivery device 200 can be restricted, and when sealing plunger 204 is moved away or otherwise separated from seal 206, fluid flow through sample container delivery device 200 may be unrestricted. In some examples, sealing plunger 204 can be tensioned via spring 205 against seal 206 such that in a default configuration, sealing plunger 204 can be pressed up against seal 206 and fluid flow through sample container delivery device 200 can be restricted. In some examples, spring 205 can be fabricated from a non-reactive material, such as 316 stainless steel coated with a ceramic material using a chemical vapor deposition (CVD) process. Fluid flow (e.g., air being drawn into a vacuum source) through sample container delivery device 200 can be allowed by causing sealing plunger 204 to move away from seal 206 (e.g., via mechanical means such as a pin from above, or other means). For example, a vacuum source can be coupled to the sample container delivery device 200 at the valve end 214 to open sealing plunger 204 and draw a vacuum through sealing plunger 204, an internal channel 230, and lower cavity 220. Additionally, in some examples, sealing plunger 204 can remain open (e.g., during continuous vacuum evacuation) to evaporate unwanted matrix, such as solvent, water, or alcohol, from the sample.

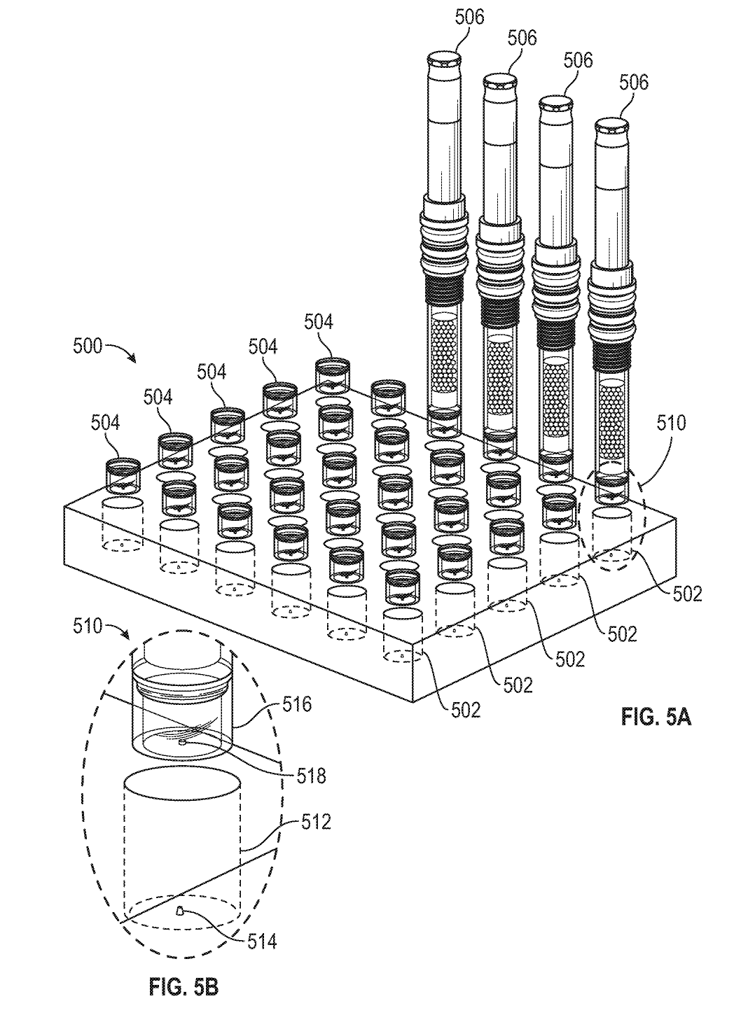

As an example, during a solvent evaporation process in which solvent can be evaporated from a sample container, as will be described in more detail below, a vacuum can be drawn through sealing plunger 204, internal channel 230 and lower cavity 220 to facilitate solvent evaporation through solvent evacuation port 232. In some examples, after the solvent has been evaporated, the sealing plunger 204 can be opened to release the vacuum. Subsequently, in some examples, during the chemical analysis process, a carrier fluid can be drawn through sealing plunger 204, into internal channel 230 and lower cavity 220, and into chemical analysis device 160. Additionally or alternatively, in some examples, during the chemical analysis process, the carrier fluid can be drawn through solvent evacuation port 232 (e.g., instead of through sealing plunger 204), into internal channel 230 and lower cavity 220, and into chemical analysis device 160. In some examples, solvent evacuation port 232 can be a channel in fluid communication with lower cavity 220 and the outside of sample container delivery device 200. Preferably, the open end of solvent evacuation port 232 can be located between external seals 208 so that solvent evacuation port 232 can be sealed when the sample container delivery device 200 is sealed against another object (e.g., a desorption device), for example. In some examples, other locations on sample container delivery device 200 are possible. In some examples, the valve end 214 can function as the solvent evacuation port 232. In other words, valve end 214 can be the same as solvent evacuation port 232, can be different from solvent evacuation port 232, the valve end 214 can be configured to perform the same functions as solvent evacuation port 232, or vice versa, for example. In some examples, an autosampler device for use with one or more sample container delivery devices 200 can pick up the sample container delivery device from the valve end 214 and perform evacuation through the valve end. During evacuation, the solvent evacuation port 232 can be sealed by a seal mounted on a sample container tray, such as sample container tray 500 described below with reference to FIGS. 5A-B.

The sample container delivery device 200 can further include one or more external seals 208, for example. As an example, the external seals 208 can be made of an elastomeric material and can be fluoroelastomer seals or perfluoroelastomer seals. In some examples, the external seals 208 can be Viton™ seals or other suitable seals. The external seals 208 can be located externally on sample container delivery device 200 between ends 212 and 214. The external seals 208 can include one or more gaskets or o-rings fitted around the outside of the sample container delivery device 200, for example. In some examples, the external seals 208 can be used to form a seal between sample container delivery device 200 and desorption device 101 into which sample delivery device 200 can be inserted during a sample delivery process (as described previously).

The sample container delivery device 200 can further include a fastener 216 on the fastener end 212, for example, via which a sample container (including sample) can be removably coupled. Fastener 212 can be any one of a flexible connector, threads, detents, snaps, clips, or any other suitable fastening feature. In some examples, coupling the sample container delivery device 200 to a sample container causes sample container to be in fluid communication with lower cavity 220 of sample container delivery device 200.

FIG. 2B illustrates another exemplary sample container delivery device 210 according to examples of the disclosure. In some examples, sample container delivery device 210 can be similar to sample container delivery device 200 and can correspond to sample container delivery device 100 in FIG. 1 to be used in a chemical analysis process similar to that described with respect to FIG. 1. Sample container delivery device 210 can include similar components to sample container delivery device 200, such as external seal 228, lower cavity 221, fastener end 213, a valve end 215, and fastener 217. In some examples, sample container delivery device 210 can be used to evaporate solvent to increase detection sensitivity during GC and/or GCMS analysis (as will be described in more detail below).

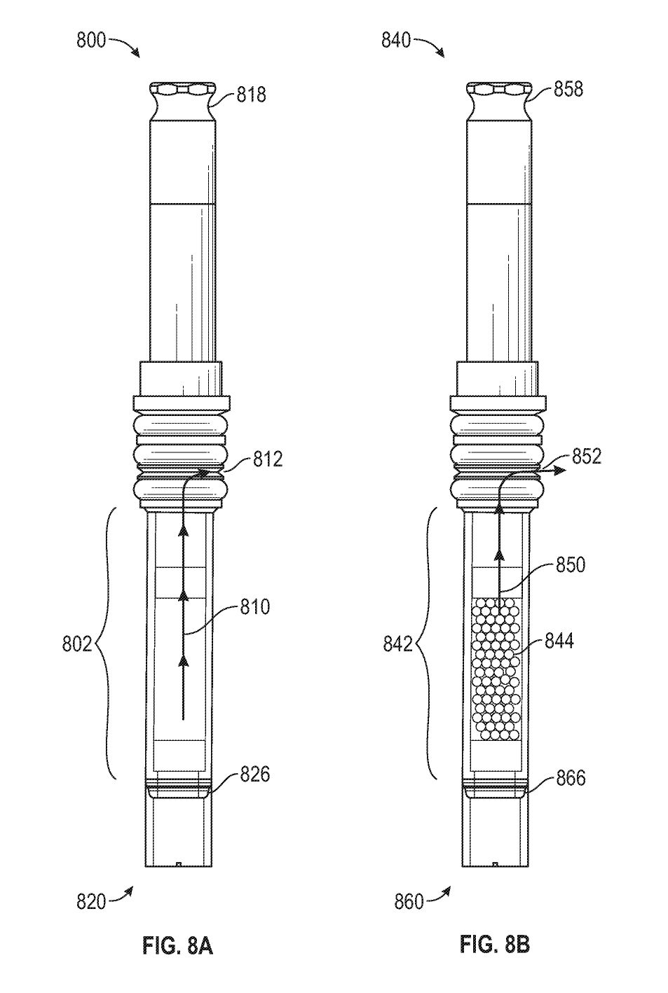

In addition to components in common with sample container delivery device 200, sample container delivery device 210 can include a sorbent 202 in lower cavity 221. The sorbent 202 can be, for example, an adsorbent or an absorbent. The sorbent can be Tenax TA, Tenax/Carboxen, a short piece of 0.53 mm ID porous layer open tubular (PLOT) column ranging in composition from polydimethylsiloxane (PDMS), PLOT Q, and/or carboxen, or some other sorbent that can be chosen based on the solvent and/or sample(s) to be delivered by the sample container delivery device 210, for example. As will be described below, in some examples, sorbent 202 can be selected to have a low affinity for the selected solvent. In some examples, the sorbent 202 can be located towards a fastener end 213 of the sample container delivery device 210. That is to say, sorbent 202 can be closer to the fastener end 213 of the sample container delivery device 210 than it is to the valve end 215 of the sample container delivery device 210. Fastener end 213 of the sample container delivery device 210 can be fluidly couplable to a sample container such that a sample being delivered can enter lower cavity 221 of the sample container delivery device 210, and can adsorb or absorb to sorbent 202, as will be described in more detail below with respect to, e.g., FIG. 8A-8B.

FIG. 2C illustrates another exemplary sample container delivery device 220 according to examples of the disclosure. In some examples, sample container delivery device 220 can be similar to sample container delivery device 200 and 210 and can correspond to sample container delivery device 100 in FIG. 1 to be used in a chemical analysis process similar to that described with respect to FIG. 1. Sample container delivery device 220 can include similar components to sample container delivery device 200 and 210, such as external seal 209, solvent evacuation port 234, lower cavity 222 with sorbent 203, a valve end 218, and fastener 219, and can include various components of sample container delivery device 200 and 210 not illustrated in FIG. 2C (e.g., sealing plunger 204 for pulling vacuum and/or selectively allowing solvent flow through the sample container delivery device 220, spring 205, and internal seal 206), except as otherwise described here.

In addition to components in common with sample container delivery device 200 and 210, sample container delivery device 220 can include threads 211 via which lower cavity 222 (including sorbent 203) can be attached to the remainder of the sample container delivery device 220, and/or a sorbent retention feature 207, for example. In some examples, the sorbent retention feature 207 can be one or more screens, frits, or seals between which sorbent 203 can be contained in lower cavity 222, and which can confine sorbent 203 within lower cavity 222 such that sorbent 203 will not be expelled from sample container delivery device 220 during solvent-evaporation of the sample from the sample container delivery device 220. As such, the sorbent retention feature 207 can be solvent-transmissive but not sorbent-transmissive. Solvent evaporation can be conducted manually or in an automated manner, for example.

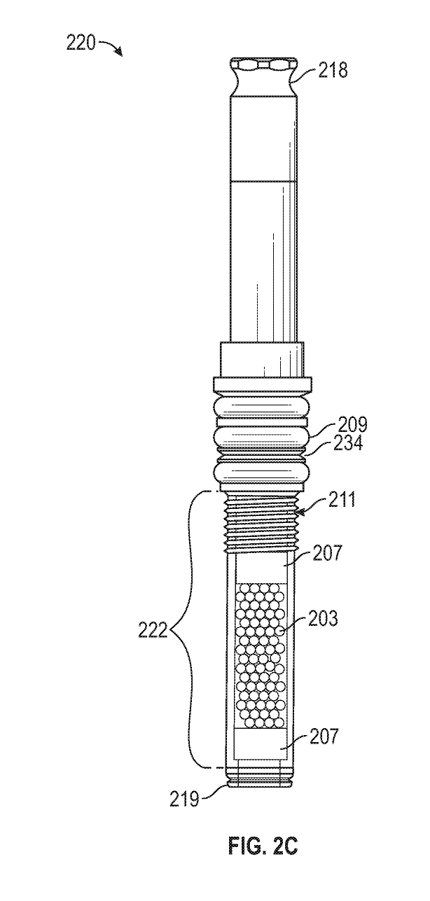

FIG. 3A illustrates an exemplary sample cup 300 according to examples of the disclosure. In some examples, sample cup 300 may correspond to sample container 102 in FIG. 1 to be used in a chemical analysis process similar to that described with respect to FIG. 1. It should be understood that sample cup 300 is an exemplary sample container. For example, other sample containers may be used. In some examples, sample cup 300 can have a diameter between 1/32 in. and ⅜ in. (e.g., the external or internal diameter); in some examples, the diameter of sample cup 300 can be as small as the diameters of the capillary columns (e.g., pre-column 162 and/or column 164) in the chemical analysis device 160. In some examples, other dimensions are possible. In some examples, sample cup 300 can accommodate any sample volume between 5 μL and 200 μL. In some examples, accommodating other volumes is possible. Sample cup 300 can comprise a beaker-like structure, for example, with a deposition end 302 and a delivery end 304. In some examples, sample cup 300 can be fabricated from stainless steel, glass, or another suitable material (e.g., a material that is substantially inert). All or part of the surface of sample cup 300 can be coated with a chemical vapor deposition (CVD)-deposited ceramic to increase the inertness of the sample cup 300, for example. Other coatings that similarly increase the inertness of the sample cup 300 can similarly be used.

In some examples, deposition end 302 can be a fastener end (e.g., when deposition end 302 includes a fastener 306). Fastener 306 on sample cup 300 may be adapted to be removably coupled to fastener 216 on fastener end 212 of sample container delivery device 200, for example. The fastener 306 can be one of a flexible connector, threads, detent, snaps, clips, or any other suitable fastening method. In some examples, deposition end 302 does not include a fastener (e.g., when sample cup 300 is not coupled to sample container delivery device 200). In some examples, coupling to sample container delivery device 200 causes sample cup 300 to be in fluid communication with lower cavity 220 of sample container delivery device 200.

In some examples, sample cup 300 can include a sample delivery port 308 (e.g., hole, grommet, flap, etc.) on delivery end 304 (e.g. opposite the fastener end 302 of sample cup 300). In some examples, sample delivery port 308 is adapted to allow the concentrated sample (e.g., one or more compounds of interest and any remaining solvent) to be delivered from sample cup 300 to chemical analysis device 160 (as was described previously, e.g., with respect to FIG. 1). In some examples, sample delivery port 308 can have a diameter between 0.01 in to 0.04 in. In some examples, other dimensions are possible, and can depend on the compounds of interest to be delivered to chemical analysis device 160. In some examples, sample delivery port 308 can be adapted to selectively restrict the concentrated sample from passing through sample delivery port 308 before insertion into chemical analysis device 160. In some examples, the concentrated sample can be a residue, thereby having a viscosity high enough to reduce or avoid leaking from the sample delivery port 308 until the sample cup 310 is coupled to the chemical analysis device 160. For example, concentrated sample may pass through sample delivery port 308 when inserted into chemical analysis device 160, such as by elution, desorption, capillary action, diffusion, effusion, or any other suitable method.

FIG. 3B illustrates an exemplary sample cup 310 according to examples of the disclosure. In some examples, sample cup 310 may be similar to sample cup 300 and can correspond to sample container 102 in FIG. 1 to be used in a chemical analysis process similar to that described with respect to FIG. 1. It should be understood that sample cup 310 is an exemplary sample container. For example, other sample containers may be used. As an example, an extract (e.g., one or more compounds of interest and a solvent) can be deposited into sample cup 310 from deposition end 312. In some examples, the extract may be deposited using a syringe, pipette, or another suitable device. In some examples, the extract may contain one or more compounds of interest 322 and a solvent 320. Solvent 320 may be any type of solvent compatible with the compound of interest 322 to be analyzed, for example. Although compound of interest 322 is illustrated as distinct compounds, this is not meant to be limiting. For example, the compound of interest 322 to be analyzed may include foods, beverages, blood, urine, breath condensate, or other samples. As will be described in further detail below, evaporated solvent 320 (all, substantially all, or a portion of the solvent) may exit the sample cup 310 from deposition end 312, for example. In some examples, boiling chips can be deposited into sample cup 310 to reduce or eliminate super-heating or rapid boiling of solvent, as will be described in further detail below. In some examples, once the sample cup 310 is coupled to a chemical analysis device (e.g., by way of a desorption device), the concentrated sample (e.g., one or more compounds of interest 322 and any remaining solvent) can pass through the sample delivery port 318 into the chemical analysis device. In some examples, the sample delivery port 318 is sized to reduce or prevent delivery of boiling chips into the chemical analysis device. In some examples, sample cup 310 can be discarded after one use. In some examples, sample cup 310 may be reused.

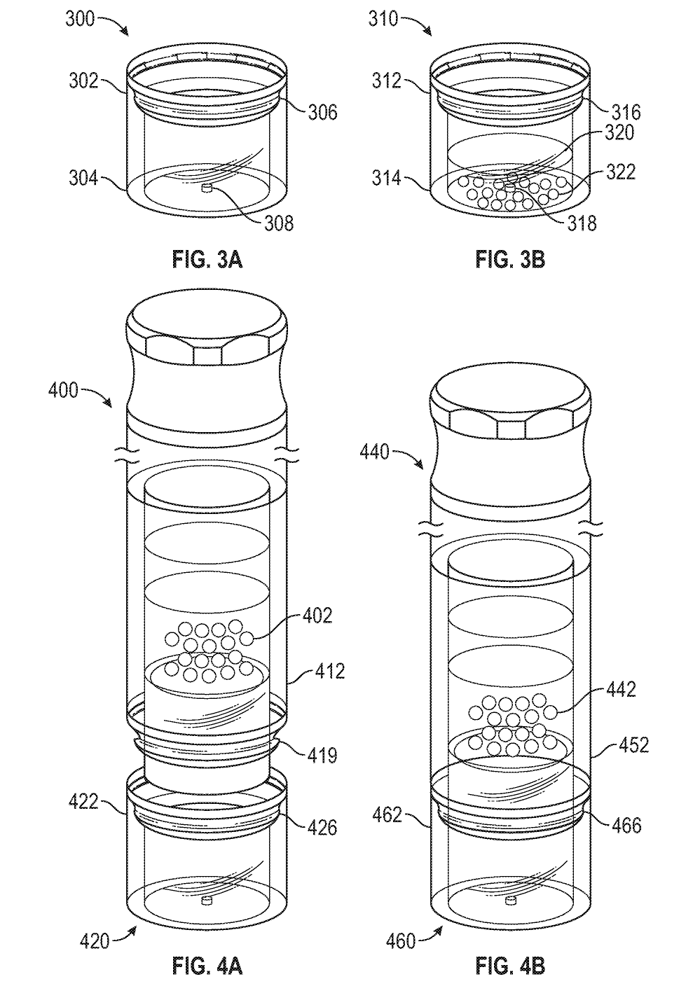

FIG. 4A illustrates an exemplary sample container delivery device 400 coupled to an exemplary sample cup 420 according to examples of the disclosure. In some examples, sample container delivery device 400 can be similar to sample container delivery device 200, 210, and 220, and can correspond to sample container delivery device 100 in FIG. 1 to be used in a chemical analysis process similar to that described with respect to FIG. 1. In some examples, sample cup 420 can be similar to sample cup 300 and 310 and can correspond to sample container 102 in FIG. 1. It should be understood that sample cup 420 is an exemplary sample container. For example, other sample containers may be used. In some examples, sample container delivery device 400 may include a fastener 419 on fastener end 412. Sample cup 420 may have a complementary fastener 426 on fastener end 422, for example. In some examples, one or both of fasteners 419 and 426 may include an internal seal (not shown). For example, one or more included internal seals may prevent fluid from escaping when sample container delivery device 400 is coupled to sample cup 420. The internal seal can be a graphite seal, a Graphite Vespel seal, or any other suitable seal, for example.

FIG. 4B illustrates an exemplary sample container delivery device 440 coupled to an exemplary sample cup 460 according to examples of the disclosure. Sample container delivery device 440 can be similar to sample container delivery device 400, and can correspond to sample container delivery device 100 in FIG. 1 to be used in a chemical analysis process similar to that described with respect to FIG. 1. Sample cup 460 can be similar to sample cup 420 and can correspond to sample container 102 in FIG. 1. It should be understood that sample cup 460 is an exemplary sample container. For example, other sample containers may be used. In some examples, sample container delivery device 440 may be removably coupled to sample cup 460 to form a coupled fastener assembly 466. In some examples, coupling sample cup 460 to sample container delivery device 440 causes the lower cavity of sample container delivery device 440 to be in fluid communication with sample cup 460.

FIGS. 5A-5B illustrate an exemplary sample container tray 500 according to examples of the disclosure. In some examples, sample container tray 500 contains recessions 502 which can accommodate a plurality of sample cups 504. In some examples, recessions 502 can be deeper than the height of sample cups 504 (e.g., to enhance the coupling between sample cups 504 and sample container delivery device 506). In some examples, other depths can be possible (e.g., the depth of recessions 502 can be the same as the height of sample cups 504, or shallower than the height of sample cups 504). Sample cups 504 can correspond to sample cups 300 or 310 in FIG. 3A-3B, for example. It should be understood that sample cup 504 is an exemplary sample container. For example, other sample containers may be used. In some examples, recessions 502 can be arranged in a grid-like manner. As illustrated, sample container tray 500 may contain 30 recessions, for example. In some examples, sample container tray 500 can contain a different number of recessions 502. As illustrated in FIG. 5B, in some examples, one or more recessions 502 of sample container tray 500 may include a plug 514 that, when the sample cup 516 is lowered into recession 512, can seal the sample delivery port 518 on sample cup 516 and can reduce or prevent escape of sample. In some examples, plug 514 can be tapered (e.g., smaller diameter at the top, wider diameter at the base) to form a compression seal that can reduce or prevent the sample from leaking from the sample delivery port 518 at the bottom of the sample cup 516. For example, the plug 514 can be formed of polyethylene, polypropylene, or any other suitable material (e.g., a material inert to solvent used to extract the sample).

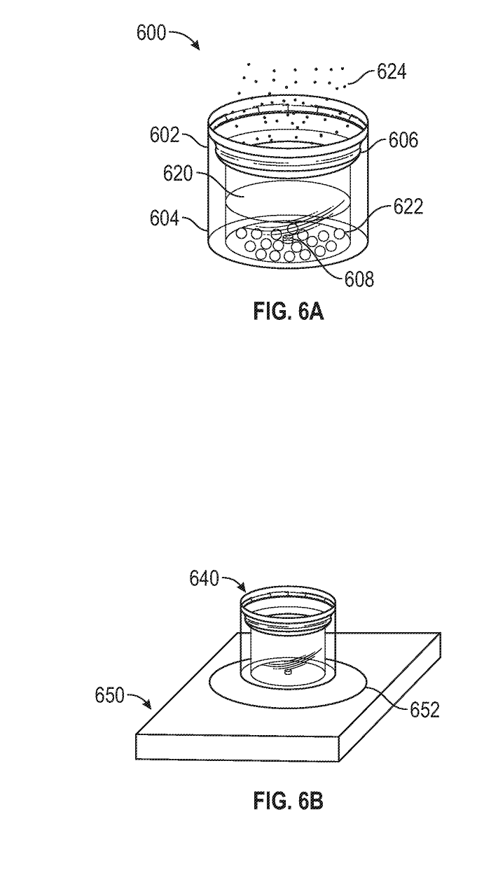

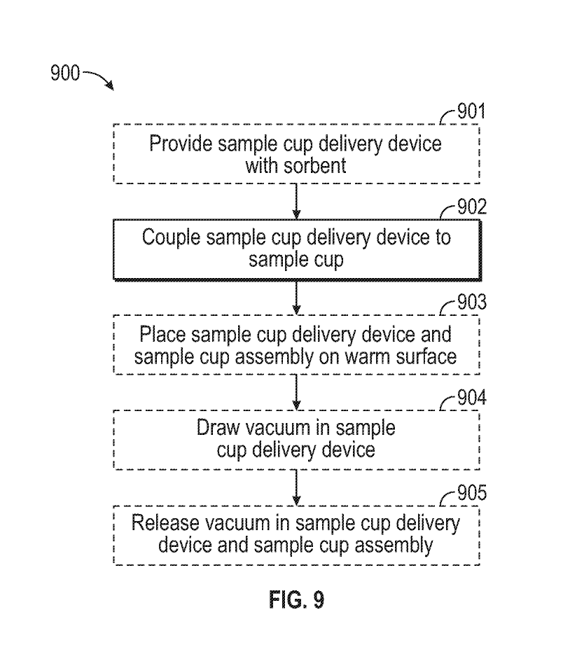

As an example, during a extract depositing process in which an extract can be deposited into sample cup 504 (as described previously, e.g., with respect to FIG. 3B), a sample cup 504 (e.g., not coupled to a sample container delivery device 506) may be accommodated into a recession 502. For example, recessions 502 can securely hold sample cups 504 for ease of depositing extract into the sample cups 504. In some examples, sample container delivery device 506 may be coupled to sample cup 504 while sample cup 504 is placed into and accommodated in recessions 502 in sample container tray 500. The solvent evaporation process (described in further detail below, e.g., with respect to FIGS. 6-9) may be performed while sample cup 504 is accommodated in sample container tray 500, with or without being coupled to sample container delivery device 506, for example. In some examples, recession 502 can be sized such that solvent evacuation port of sample container delivery device 506 is sealed by the side walls of the recession 502 to allow a vacuum to be drawn from the valve end of the sample container delivery device 506 (as will be described in more detail below with respect to, e.g., FIGS. 8-9).

FIG. 6A illustrates an exemplary sample cup 600 according to examples of the disclosure. In some examples, sample cup 600 can be similar to sample cup 300 and 310 and can correspond to sample container 102 in FIG. 1 to be used in a chemical analysis process similar to that described with respect to FIG. 1. It should be understood that sample cup 600 is an exemplary sample container. For example, other sample containers may be used. In some examples, sample cup 600 can include a deposited extract. For example, the extract can contain one or more compounds of interest 622 and solvent 620, as previously described. In some examples, all, substantially all, or a portion of the solvent 620 in sample cup 600 may be evaporated. In some examples, evaporated solvent 624 may exit the sample cup 600 from deposition end 602. In some examples, solvent evaporation is achieved at atmospheric pressure. In some examples, the solvent 620 can evaporate at room temperature. In some examples, a vacuum can be drawn on the sample cup 600 to aid evaporation. For example, the evaporation rate of the solvent 620 may be proportional to the vapor pressure of the solvent 620. In some examples, the solvent 620 can have a higher vapor pressure, thereby evaporating faster, than the compounds of interest 622. In some examples, after evaporation of all, substantially all, or a portion of the solvent 620, all or substantially all of the compounds of interest 622 remains in the sample cup 600. Preliminary reduction or elimination of the solvent 620 can improve the injection rate, reduce or eliminate analyzer contamination risk caused by back expansion of the solvent 620 and sample into carrier gas delivery lines, and can increase the overall amount of compounds of interest 622 delivered into the chemical analysis device, for example. In some examples, the concentrated sample (e.g., one or more compounds of interest 622 and any remaining solvent) can increase the amount of compounds of interest 622 delivered into a chemical analysis device. In some examples, increasing the amount of one or more compounds of interest delivered into the chemical analysis device can increase the detection sensitivity of the chemical analysis. In some examples, when extra sensitivity may not be needed, analyzing a larger fraction of the extract decreases the amount of sample needing to be extracted in the first place, thereby allowing less solvent to be used, which can result in a greener analytical technique that is better for the environment.

FIG. 6B illustrates an exemplary sample cup 640 according to examples of the disclosure. In some examples, sample cup 640 can be similar to sample cup 600 and can correspond to sample container 102 in FIG. 1 to be used in a chemical analysis process similar to that described with respect to FIG. 1. It should be understood that sample cup 640 is an exemplary sample container. For example, other sample containers may be used. In some examples, sample cup 640 may be heated or warmed (e.g., placed on a warm or hot surface 652) to aid in evaporating solvent 620. The warm surface may be a hot plate 650, the inside of an oven, or any other suitable heating means, for example. In some examples, boiling chips may be deposited into sample cup 640 before sample cup 640 is heated or warmed. Boiling chips may provide a nucleation site to reduce or prevent super-heating or rapid and violent boiling of the solvent when the solvent is heated or warmed, in some examples. In some examples, boiling chips can be glass beads or any other suitable material (e.g., a material that is substantially inert).

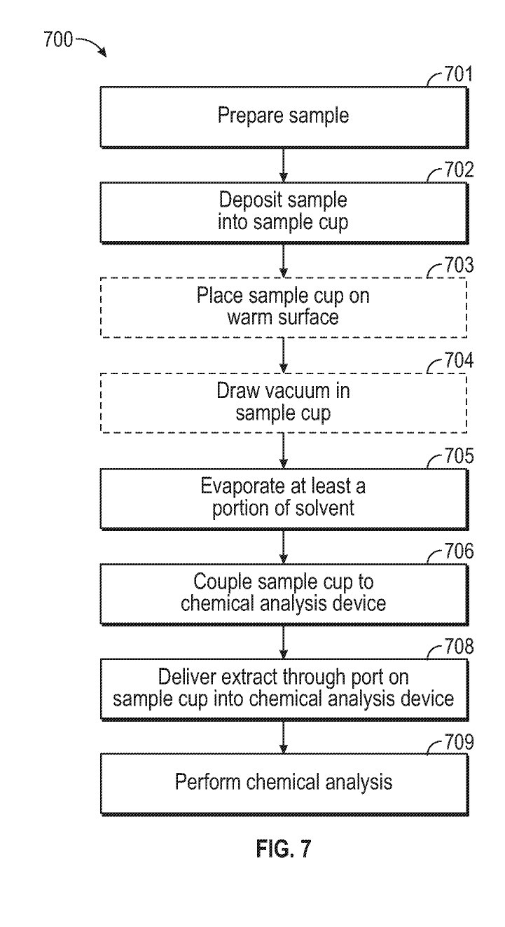

FIG. 7 illustrates an exemplary process 700 for performing chemical analysis of a sample according to examples of the disclosure. For example, in step 701 of process 700, the sample can be prepared (e.g., extracting one or more compounds of interest from an environment using a solvent and a sample extraction device to create an extract). In some examples, in step 702 of process 700, the extract can be deposited into a sample container. Depositing the extract into sample container can include inserting the sample container into a sample container tray, for example. In some examples, depositing the extract may be performed using a syringe, pipette, or another suitable device. The deposited extract may include one or more compounds of interest to be analyzed and solvent compatible with the compounds, for example. In some examples, depositing the extract can include depositing boiling chips into the sample container (e.g., if sample container is heated or warmed in step 703).

In some examples, after deposition of a sample into the sample container, in step 703, the sample container optionally may be heated or warmed (e.g., placed on a warm or hot surface). In some examples, heating or warming the sample container can be performed at 20° C. to 30° C. and take five to thirty minutes, though other temperatures and lengths of time are possible. In some examples, boiling chips deposited into the sample container may reduce or prevent super-heating or rapid and violent boiling of the solvent when the solvent is heated or warmed. Alternatively or additionally, a vacuum may be optionally drawn in the sample container at step 704, in some examples. In some examples, process 700 may be performed with or without either steps 703 or 704. In step 705, all, substantially all, or a portion of the solvent may be evaporated from the sample container. In some examples, all or substantially all of the solvent can be evaporated (e.g., 80%, 90%, 100% of the solvent is evaporated). In some examples, solvent evaporation can be achieved at atmospheric pressure (as described previously, e.g., with respect to FIGS. 6A-6B). In some examples, the solvent can evaporate at room temperature. In some examples, the solvent can evaporate at an elevated temperature (e.g. the sample container is placed on a warm or hot surface at step 703) to aid in evaporating solvent (as previously described, e.g., with respect to FIG. 6B). In some examples, a vacuum can be drawn on the sample container to aid evaporation (e.g., a vacuum is drawn in the sample container at step 704). In some examples, the vacuum can reduce the pressure to between 0.5 psi absolute and 7.5 psi absolute (i.e., between 15″ and 29″ Hg), or any other suitable pressure. For example, the pressure can be selected to reduce or prevent rapid boiling or aerosol formation. In some examples, the difficulty of holding a given pressure can indicate that all or substantially all of the solvent has been evaporated. Once all, substantially all, or a at least a portion of the solvent has been evaporated, the sample container containing the concentrated sample (e.g., one or more compounds of interest and any remaining solvent) may be coupled to the chemical analysis device in step 706. In some examples, a sample container delivery device may be used to couple the sample container to the chemical analysis device (e.g., by first coupling the sample container delivery device to the sample container and then coupling the sample container delivery device to the chemical analysis device similar to the process described with respect to FIGS. 1A-1B). In some examples, other types of sample container delivery devices can be used to couple the sample container to the chemical analysis device. After the sample container is coupled to the chemical analysis device, the concentrated sample (e.g., one or more compounds of interest and any remaining solvent) may be delivered into the chemical analysis device in step 708. The concentrated sample may pass through a sample delivery port on the sample container, for example. In some examples, the concentrated sample can be delivered into the chemical analysis device by desorption, capillary action, or any other suitable method. For example, the concentrated sample can be delivered into the chemical analysis device using a desorption device (as described previously, e.g., with respect to FIG. 1A-1B). In some examples, sample delivery can be achieved by flowing a carrier fluid from pressure controller through sample container delivery device and sample container to the chemical analysis device. Depending on the chemical analysis procedure and in the disclosed configuration, the carrier fluid can be a gas (e.g., for GC or GCMS), though it is understood that in some configurations, the carrier fluid can be a liquid (e.g., for LC or LCMS). In some examples, the carrier fluid desorbs evaporated compounds of interest, if any, from the sorbent in the sample container delivery device and reintroduces the evaporated compounds into the concentrated sample. In some examples, the concentrated sample (i.e., the compounds remaining in the sample container along with those collected in the sorbent) can be delivered into the pre-column or primary column of chemical analysis device. At step 709, chemical analysis device may perform analysis on the delivered compounds. In some examples, the chemical analysis may be GC, GCMS, LC, LCMS, or some other analysis procedure to evaluate one or more characteristics of the compounds, such as its composition.

FIG. 8A illustrates an exemplary sample container delivery device 800 coupled to an exemplary sample cup 820 according to examples of the disclosure. In some examples, sample container delivery devices 800 can be similar to sample container delivery devices 200, 210, and 220 and can correspond to sample container delivery device 100 in FIG. 1 to be used in a chemical analysis process similar to that described with respect to FIG. 1. In some examples, the sample container delivery device can include sample evacuation port 812, lower cavity 802, valve end 818, and fastener 826. In some examples, sample cup 820 can be similar to sample cups 300 and 310 and can correspond to sample container 102 in FIG. 1 to be used in a chemical analysis process similar to that described with respect to FIG. 1. It should be understood that sample cup 820 is an exemplary sample container. For example, other sample containers may be used. In some examples, sample container delivery device 820 does not contain sorbent in lower cavity 802, as illustrated in FIG. 8A. As was described previously with respect to FIG. 4A-4B, in some examples, sample container delivery device 800 can be coupled to sample cup 820 by fastener 826. Sample cup 820 may contain a sample consisting of a solvent and one or more compounds of interest to be analyzed, for example. In some examples, the solvent can be evaporated while the sample cup 820 is coupled to the sample container delivery device 800 (e.g., as described in steps 703, 704 and/or 705). The evaporated solvent 810 can exit the sample container delivery device 800 through the solvent evacuation port 812, for example. In some examples, evaporated solvent 810 can exit the sample container delivery device 800 through the valve end 818 (e.g., if solvent evacuation port 812 is sealed by a sample container tray or a desorption device, for example). In some examples, after evaporation of all, substantially all, or a portion of the solvent 810, all or substantially all of the compounds of interest remains in the sample cup 820 in an increased concentration.

In some examples, a vacuum can be drawn in the sample container delivery device 800 and sample cup 820 assembly. As was described previously with respect to FIG. 1A-1B, a vacuum source can be coupled to the valve end 818 of sample container delivery device 800 to open a sealing plunger and draw a vacuum through the sealing plunger, an internal channel, lower cavity 802, and sample cup 820. In some examples, a vacuum source can be coupled to solvent evacuation port 812 to draw a vacuum in the sample container delivery device 800 and sample cup 820 assembly. In some examples, a vacuum source can be coupled to both the valve end 818 and the solvent evacuation port 812 of the sample container delivery device 800. In some examples, the vacuum may decrease the atmospheric pressure in the sample container delivery device 800 and sample cup 820 assembly, which can increase the evaporation rate of the solvent. In some examples, other means of evaporation can be used.

FIG. 8B illustrates an exemplary sample container delivery device 840 coupled to an exemplary sample cup 860 according to examples of the disclosure. In some examples, sample container delivery device 840 can be similar to sample container delivery device 800 and can correspond to sample container delivery device 100 in FIG. 1 to be used in a chemical analysis process similar to that described with respect to FIG. 1. In some examples, the sample container delivery device 840 can include sample evacuation port 852, lower cavity 842, valve end 858, and fastener 866. In some examples, sample cups 860 can be similar to sample cups 820 and can correspond to sample container 102 in FIG. 1 to be used in a chemical analysis process similar to that described with respect to FIG. 1. It should be understood that sample cup 860 is an exemplary sample container. For example, other sample containers may be used. In some examples, the sample container delivery device 840 can contain sorbent 844 in the lower cavity 842 of sample container delivery device 840. In some examples, sorbent 844 can be selected to allow solvent to pass through the sorbent 844 (e.g., not substantially absorb or adsorb to sorbent 844). In some examples, sorbent 844 can be selected to adsorb or absorb any evaporated compounds. The solvent evaporation process can evaporate at least a portion of the solvent, for example (e.g., as described in steps 703, 704 and/or 705). In some examples, all or substantially all of the solvent can be evaporated. Evaporated solvent 850 can pass through the sorbent 844 and can exit the sample container delivery device 840 through solvent evacuation port 852, for example. In some examples, a portion of the compounds of interest can be evaporated. The evaporated compounds of interest may not substantially pass through the sorbent 844 (e.g., less than 20%, 10% or 5% of the evaporated compounds of interest may pass through sorbent 844 and exit from port 852) and may instead be adsorbed or absorbed by the sorbent 844, for example. In some examples, after evaporation of all, substantially all, or a portion of the solvent, all or substantially all of the compounds of interest can remain in the sorbent or in the sample cup 860 in an increased concentration.

FIG. 9 illustrates an exemplary process 900 for using a sample container delivery device according to examples of the disclosure. In some examples, in step 901 of process 900, sorbent may be provided to sample container delivery device. Providing sorbent to sample container delivery device may include selecting an appropriate sorbent, as was described previously. In some examples, sorbent may be placed in the lower cavity of sample container delivery device. In some examples, sorbent can be held in place by a sorbent retention means.

In some examples, sorbent is preferably used when the one or more compounds of interest have a high volatility that is prone to evaporation (e.g. light compounds). In some examples, the sorbent may be selected to allow evaporated solvent to pass through the sorbent. In some examples, the sorbent may adsorb or absorb any evaporated compounds of interest and reduce or eliminate loss of these compounds. In some examples, sorbent is not used when the one or more compounds of interest has a low volatility (e.g. heavy compounds). In some examples, step 901 can be skipped; for example, rather than providing the sample container delivery device with sorbent, the sample container delivery device may be used without sorbent.

Next, in step 902, the sample container delivery device may be removably coupled to a sample container. In some examples, sample container delivery device can correspond to sample container delivery device 100 in FIG. 1 or sample container delivery device 800 in FIG. 8A. In some examples, other sample container delivery devices can be used. In some examples, evaporation of solvent may occur before coupling the sample container delivery device to the sample container in step 902. Additionally or alternatively, evaporation of solvent may occur after coupling the sample container delivery device to the sample container in step 902. In some examples, coupling sample container delivery device to sample container can be achieved by a fastener (as was described previously, e.g., with respect to FIGS. 4A-4B). In some examples, coupling is achieved by one of threading sample container to sample container delivery device, snapping sample container to sample container delivery device, or any other suitable fastening method. After coupling, the lower cavity of sample container delivery device may be in fluid communication with sample container, such that evaporated solvent can evaporate through the sample container delivery device and/or carrier fluid can flow through the sample container delivery device into the sample container.

After coupling the sample container delivery device to sample container, in step 903, the sample container delivery device and sample container assembly may optionally be heated or warmed (e.g., placed on a hot or warm surface), in some examples. Alternatively or additionally, a vacuum may be optionally drawn in the sample container at step 904, in some examples. As was described previously with respect to FIG. 8A-8B, a vacuum source can be coupled to the valve end and/or the solvent evacuation port of the sample container delivery device to open a sealing plunger and draw a vacuum through the sealing plunger, an internal channel, lower cavity, and sample container.

In some examples, heating the sample container delivery device and sample container assembly or drawing a vacuum may increase the volatility of the solvent in the sample container. For example, steps 903 and 904 may increase the evaporation rate of the solvent in the sample container. In some examples, evaporated solvent can pass through the sorbent in the sample container delivery device. For example, evaporated solvent may escape through the solvent evacuation port on the sample container delivery device. In some examples, evaporated solvent may escape through the valve end of the sample container delivery device. In some examples, the sample container delivery device and sorbent can be temperature matched with the solvent to reduce or prevent re-condensation of the evaporated sorbent. In some examples, the one or more compounds of interest in the sample container may also evaporate. In some examples, all or substantially all of the evaporated compounds may be absorbed or adsorbed by the sorbent in the sample container delivery device. In some examples, no or substantially no compounds of interest may pass through the sorbent in the sample container delivery device. In some examples, the solvent evaporation process may evaporate all, substantially all, or a portion of the solvent, thus increasing the concentration of the compounds of interest in the sample container. Preliminary reduction or elimination of the solvent can improve the injection rate, reduce or eliminate analyzer contamination risk caused by back expansion of the solvent and sample into carrier gas delivery lines, and can increase the overall amount of compounds of interest delivered into the chemical analysis device, for example. In some examples, increasing the concentration of one or more compounds of interest delivered into the chemical analysis device and used during each analysis can increase the detection sensitivity during chemical analysis. In some examples, when extra sensitivity may not be needed, analyzing a larger fraction of the extract decreases the amount of sample needing to be extracted in the first place, thereby allowing less solvent to be used, which can result in a greener analytical technique that is better for the environment. In some examples, process 900 may be performed with or without either steps 903 or 904. In other words, solvent evaporation may be achieved at atmospheric pressure and/or at room temperature.

Next, in step 905, the vacuum may be optionally released in the sample container delivery device and sample container assembly. Releasing the vacuum may involve, for example, removing the sample container delivery device and sample container assembly from the sample container tray. In some examples, releasing the vacuum may not cause the sample to pass through the sample delivery port on the sample container (e.g., due to ambient air flowing into the sample container, for example). After removing the sample container delivery device and sample container assembly from the sample container tray, in some examples, the concentrated sample (e.g., one or more compounds of interest and any remaining solvent) can be delivered into the chemical analysis device to evaluate one or more characteristics of the compounds, such as its composition. In some examples, sample delivery can be achieved by flowing a carrier fluid from pressure controller through sample container delivery device and sample container to the chemical analysis device. In some examples, the carrier fluid desorbs evaporated compounds that have been adsorbed or absorbed, if any, from the sorbent in the sample container delivery device and reintroduces the evaporated extract into the concentrated sample as the concentrated sample is delivered into the chemical analysis device.

As such, the examples of the disclosure provide an improved method of performing chemical analysis on a sample by, for example, evaporating all, substantially all, or at least a portion of the solvent before delivering the sample into a chemical analysis device for analysis.

Therefore, according to the above, some examples of the disclosure are related to a method of performing a chemical analysis of a sample, the method comprising depositing the sample into a sample container, wherein the sample includes one or more compounds and a solvent; evaporating at least a portion of the solvent from the sample; after evaporating at least a portion of the solvent from the sample, delivering the one or more compounds into a chemical analysis device. Additionally or alternatively, in some examples, wherein evaporating at least a portion of the solvent from the sample comprises evaporating substantially all of the solvent from the sample. Additionally or alternatively, in some examples, evaporating at least a portion of the solvent from the sample comprises one of evaporating at room temperature or at an elevated temperature. Additionally or alternatively, in some examples, evaporating at least a portion of the solvent from the sample comprises drawing a vacuum in the sample container. Additionally or alternatively, in some examples, method further includes coupling a sample container delivery device to the sample container. Additionally or alternatively, in some examples, evaporating at least a portion of the solvent from the sample comprises evaporating at least the portion of the solvent through a solvent evacuation port on the sample container delivery device. Additionally or alternatively, in some examples, evaporating at least a portion of the solvent from the sample comprises drawing a vacuum through a sorbent included in the sample container delivery device. Additionally or alternatively, in some examples, the method further includes coupling the sample container to a column of the chemical analysis device. Additionally or alternatively, in some examples, delivering the one or more compounds into the chemical analysis device comprises passing the one or more compounds through a sample delivery port on the sample container into a column of the chemical analysis device. Additionally or alternatively, in some examples, the chemical analysis device performs one or more of gas chromatography, gas chromatography-mass spectrometry, liquid chromatography, and liquid chromatography-mass spectrometry on the one or more compounds.

Some examples of the disclosure are related to a cavity configured to contain a sample, the cavity having a deposition end and a delivery end opposite to the deposition end; and a sample delivery port configured to selectively restrict fluid flow through the cavity, the sample delivery port disposed on the delivery end of the sample container. Additionally or alternatively, in some examples, the sample container further comprises one or more of a flexible connector, threads, detents, snaps, or clips disposed on the deposition end. Additionally or alternatively, in some examples, the sample delivery port is configured to pass the sample into a column of a chemical analysis device.

Some examples of the disclosure are related to a base; and a plurality of recessions, the recessions configured to accommodate a plurality of sample containers, wherein one or more recessions of the plurality of recessions includes a plug configured to seal a sample delivery port on a delivery end of the sample container. Additionally or alternatively, in some examples, the plug is tapered to form a compression seal when inserted into the delivery port on the sample container. Additionally or alternatively, in some examples, the plurality of recessions is arranged in a grid.

Some examples of the disclosure are related to a cavity configured to contain a sorbent, the cavity having an opening at a fastener end of the sample container delivery device; an internal seal configured to selectively restrict fluid flow through the cavity; a solvent evacuation port configured to facilitate escape of evaporated solvent from the sample container delivery device; and a fastener disposed on the fastener end of the sample container delivery device. Additionally or alternatively, in some examples, the sorbent is disposed within the cavity such that it is closer to the opening at the fastener end of the sample container delivery device than it is to the valve end of the cavity. Additionally or alternatively, in some examples, the fastener comprises one of a flexible connector, threads, detents, snaps, or clips. Additionally or alternatively, in some examples, the fastener is configured to removably couple the sample container delivery device to a sample container. Additionally or alternatively, in some examples, the opening at the fastener end of the sample container delivery device is configured to facilitate flow of evaporated solvent through the cavity and out of the solvent evacuation port. Additionally or alternatively, in some examples, the internal seal is disposed at a valve end of the sample container delivery device.

Although examples have been fully described with reference to the accompanying drawings, it is to be noted that various changes and modifications will become apparent to those skilled in the art. Such changes and modifications are to be understood as being included within the scope of examples of this disclosure as defined by the appended claims.

What is claimed is:

1. A method of performing a chemical analysis of a sample, the method comprising:
depositing the sample into a sample container, wherein the sample includes one or more compounds and a solvent;
evaporating at least a portion of the solvent from the sample; and
after evaporating at least a portion of the solvent from the sample, delivering the one or more compounds into a chemical analysis device.

2. The method of claim 1, wherein evaporating at least a portion of the solvent from the sample comprises evaporating substantially all of the solvent from the sample.

3. The method of claim 1, wherein evaporating at least a portion of the solvent from the sample comprises one of evaporating at room temperature or at an elevated temperature.

4. The method of claim 1, wherein evaporating at least a portion of the solvent from the sample comprises drawing a vacuum in the sample container.

5. The method of claim 1, the method further comprising coupling a sample container delivery device to the sample container.

6. The method of claim 5, wherein evaporating at least a portion of the solvent from the sample comprises evaporating at least the portion of the solvent through a solvent evacuation port on the sample container delivery device.

7. The method of claim 5, wherein evaporating at least a portion of the solvent from the sample comprises drawing a vacuum through a sorbent included in the sample container delivery device.

8. The method of claim 1, the method further comprising coupling the sample container to a column of the chemical analysis device.

9. The method of claim 1, wherein delivering the one or more compounds into the chemical analysis device comprises passing the one or more compounds through a sample delivery port on the sample container into a column of the chemical analysis device.

10. The method of claim 1, wherein delivering the one or more compounds into the chemical analysis device comprises desorbing the one or more compounds.

11. The method of claim 1, wherein the chemical analysis device performs one or more of gas chromatography, gas chromatography-mass spectrometry, liquid chromatography, and liquid chromatography-mass spectrometry on the one or more compounds.

12. A sample container comprising:
a cavity configured to contain a sample, the cavity having a deposition end and a delivery end opposite to the deposition end; and
a sample delivery port configured to selectively restrict fluid flow through the cavity, the sample delivery port disposed on the delivery end of the sample container.

13. The sample container of claim 12, further comprising one or more of a flexible connector, threads, detents, snaps, or clips disposed on the deposition end.

14. The sample container of claim 12, wherein the sample delivery port is configured to pass the sample into a column of a chemical analysis device.

15. A sample container tray comprising:
a base; and
a plurality of recessions, the recessions configured to accommodate a plurality of sample containers, wherein a given recession of the plurality of recessions includes a plug configured to seal a sample delivery port on a delivery end of a given sample container when the given sample container is inserted into the given recession.

16. The sample container tray of claim 15, wherein the plug is tapered to form a compression seal when inserted into the delivery port on the sample container.

17. The sample container tray of claim 15, wherein the plurality of recessions is arranged in a grid.

18. A sample container delivery device comprising:
a cavity configured to contain a sorbent, the cavity having an opening at a fastener end of the sample container delivery device;
an internal seal configured to selectively restrict fluid flow through the cavity;
a solvent evacuation port configured to facilitate escape of evaporated solvent from the sample container delivery device; and
a fastener disposed on the fastener end of the sample container delivery device.

19. The sample container delivery device of claim 18, wherein the sorbent is disposed within the cavity such that it is closer to the opening at the fastener end of the sample container delivery device than it is to the valve end of the cavity.

20. The sample container delivery device of claim 18, wherein the fastener comprises one of a flexible connector, threads, detents, snaps, or clips.

21. The sample container delivery device of claim 18, wherein the fastener is configured to removably couple the sample container delivery device to a sample container.

22. The sample container delivery device of claim 18, wherein the opening at the fastener end of the sample container delivery device is configured to facilitate flow of evaporated solvent through the cavity and out of the solvent evacuation port.

23. The sample container delivery device of claim 18, wherein the internal seal is disposed at a valve end of the sample container delivery device.
